(19) United States
(12) Patent Application Publication
(10) Pub. No.: US 2008/0301557 A1
(43) Pub. Date: Dec. 4, 2008

(54) SYSTEMS, METHODS AND SOFTWARE PRODUCTS FOR ONLINE DATING

(76) Inventor: Igor Kotlyar, Richmond Hill (CA)

Correspondence Address: HERMAN & MILLMAN, 141 ADELAIDE ST. WEST, SUITE 1002, TORONTO, ON, M5H 3L5, CA

(21) Appl. No.: 11/757,668

(22) Filed: Jun. 4, 2007

(51) Int. Cl. G06F 3/048; G06F 3/00

(52) U.S. Cl. 715/706; 715/719; 715/733

(57) ABSTRACT

Provided by aspects of the present invention is an online dating service that provides system driven interactions in addition to and/or alternative to user driven aspects of online dating. The online dating service provides a virtual setting in which two users at a time are presented with virtual scenarios to which they react and comment on. The virtual scenarios are more than mere images or a virtual environment to be navigated through, and instead include video clips (or animation) designed to elicit the emotional reactions of each user and to catalyze less guarded conversations between the users. That is, the virtual scenario presented to the two users on the virtual date provides context to the interaction and any reaction by a first one of the users can be interpreted by a second one of the users to mean something based on the expectations of the second one of the users and vice versa. As a result, key personality information may be revealed that can be evaluated by others to determine the potential for a more significant relationship.

### FIELD OF THE INVENTION

The invention relates to establishing relationships online, and in particular to systems, methods and software products for facilitating online dating.

### BACKGROUND OF THE INVENTION

The internet has enabled numerous forms of peer-to-peer communication, interaction and sharing, of which online dating is but one example. A typical online dating website (or service) is structured according to the consumer model of choice. An individual first becomes a subscriber by completing a detailed profile, providing various attributes about himself/herself (e.g. age, weight, location, photos, interests, etc.). The individual can then search for potential matches by filtering other subscriber profiles according to the criteria the individual wishes potential matches to have. One motivation behind the use of this model is that subscribers are provided with more control to generate options for potential matches based on information required from all of the subscribers. However, in effect, an individual subscriber is initially forced to determine the potential for a match between himself/herself and another by making inferences from information in lists of attributes created by other subscribers.

The requirement to make these inferences is flawed and leads to other problems. First, an individual may intentionally provide inaccurate information about himself/herself in order to appear more attractive to others. For example, individuals may list hobbies they do not have, lie about their weight or provide pictures that are out of date. Second, the information may be too ambiguous for accurate inferences to be drawn. In turn, another person's desire to find a partner may lead them to interpret ambiguous information as evidence of similarity, leading to unrealistically high expectations and subsequent disappointment.

Third, certain types of information cannot be communicated in a list of attributes. For example, the type of information available may not be sufficient for individuals to make accurate determinations about other subscribers or the way in which the information is revealed may itself diminish the real value of the information. Choosing a partner online by sorting potential matches according to various attributes—as if choosing a car—lacks the component of real-time interaction and spontaneity desirable in the courtship process. Traditional dating requires the discomfort of getting to know someone in person, awkward pauses, bad jokes, the tension of not knowing how things may turn out, and unspoken communication between people—through body language, facial expressions and voice inflections—that reveals genuine aspects of personality in a way a written description of those aspects cannot.

In an attempt to bridge this key difference between online and offline dating, some new forms of online dating have borrowed from video gaming models, such as the first-person-shooter model. In such applications online interactions occur in a virtual environment designed to simulate places where dates might occur in the real world. Individuals navigate the virtual environment (e.g. a museum, a park, a rain-forest, etc.) and chat with one another. The interaction between users online is user driven. That is, the interactions are solely controlled by the users. For example, users ask one another questions and cooperate to navigate through the virtual environment if they choose to do so together. Discussions primarily include an exchange of demographic information (e.g. age, location, occupation, etc.) between users identical to what is available within a written online profile, and shallow banter about the design of the virtual world. Often the fear of offending and the desire to appear attractive prevents users from revealing their true thoughts on issues, opening themselves up for evaluation or asking questions they really want the answers to. But even if sensitive topics are brought up in the course of a virtual interaction they can be easily avoided and responses can be written sufficiently vague to conceal true reactions so long as the user remains composed—which may be easier to do when one is not directly confronted by the other person as they would be during a face-to-face interaction. That is, the user driven model of interacting in a virtual environment allows users to remain emotionally distant and separated from others they interact with and does not encourage users to interact in a less guarded manner. In turn, key personality information is not revealed that can be evaluated by others to determine the potential for a more significant relationship.

### SUMMARY OF THE INVENTION

According to one aspect of the invention, provided is a computer system for providing an online dating service, the system including: a server computer hosting a software product implementing an online dating service having program instructions for: a facilitator program for managing the interactions between a pair of users and content provided to the pair of users; and, a system driven interface, primarily controlled by the facilitator program and provided to respective users through use of a web-browser, for delivering content to the pair of users in order to provide context to interactions between the pair of users, the system driven interface including a display window for presenting a virtual scenario designed to elicit an emotional reaction from each of the pair of users interacting and a chat window in which the pair of users can discuss a virtual scenario presented.

In some embodiments, the virtual scenario is presented in at least one of a video clip and an animated segment. In some more specific embodiments, the system also includes a database storing a plurality of virtual scenarios.

In some embodiments, the system driven interface also includes a mentor window for providing the pair of users with at least one of advice with respect to making conversation about a virtual scenario displayed, questions that the users are prompted to answer, instructions explaining the process of a virtual date and how to use the functions of the online dating service. In some more specific embodiments, an animated figure is provided in the mentor window to convey information audibly to the users. In some other more specific embodiments, text is displayed in the mentor window to convey information to the users.

In some embodiments, the system driven interface includes a respective avatar for each user. In some more specific embodiments, the system driven interface provides a user with a respective set of controls to enable the user to control the respective avatar representing the user in an online interaction. In yet even more specific embodiments, the set of controls for controlling an avatar include a set of emoticons that represent various facial expressions, and when a user selects one of the emoticons the facial expressions and/or gestures of a respective avatar are changed either momentarily or for a prolonged period. Additionally and/or alternatively, the set of controls for controlling an avatar include a set of gestures described, and when a user selects one of the gestures a respective avatar is controlled to make the corresponding gesture. In some other embodiments, the system driven interface provides controls for enabling a user to customize the appearance of a respective avatar.

In some embodiments, the software product implementing the online dating service has further program instructions for: a user interface enabling a user to access functions of the online dating service; a subscriber database in which information about the users of the online dating service is stored in the form of respective subscriber profiles; and, a set of customs aspects that enables at least one of a user and the facilitator program to control the content provided to users.

In some more specific embodiments, the functions of the online dating service include a search engine that can be employed by users, through the user interface, to search for potential matches by filtering other subscriber profiles according to the criteria the user wishes potential matches to have. Additionally -and/or alternatively, the functions of the online dating service include a matchmaking service that pairs users for online interactions according to a set of matchmaking criteria.

Additionally and/or alternatively, the functions of the online dating service include a personality test for determining the personality type of a user. In very specific embodiments, the personality test is one of Myers-Briggs, Holland codes, Minnesota Multiphasic Personality Inventory, Morrisby Profile, MEO PI-R, Enneagram Type Indicator, Thematic Apperception Test, and Kelly's Repertory Grid.

In some embodiments, the facilitator program includes program instructions for delivering specialized content to users based on the personality type of at least one of the pair of users interacting online together using the online dating service, or based on the preferences of at least one of the pair of users interacting online together using the online dating service. In more specific embodiments, the specialized content delivered to users includes at least one of virtual scenarios, questions sets and hint sets.

In some embodiments, the functions of the online dating service include level based dating controlled by the facilitator program.

According to one aspect of the invention, provided is a software product implementing an online dating service, the software product including computer program code for: managing the interactions between a pair of users; providing content provided to the pair of users interacting online using the online dating service, wherein the content provides real-time context to online interactions; and, a system driven interface for delivering content to the pair of users, the system driven interface including a display window for presenting a virtual scenario designed to elicit an emotional reaction from each of the pair of users interacting and a chat window in which the pair of users can discuss a virtual scenario presented.

In some embodiments the software product also includes computer program code defining a database for storing a plurality of virtual scenarios. In some more specific embodiments the computer program code for the system driven interface further comprises computer program code for defining a mentor window for providing the pair of users with at least one of advice with respect to making conversation about a virtual scenario displayed, questions that the users are prompted to answer, instructions explaining the process of a virtual date and how to use the functions of the online dating service. In yet even more specific embodiments, the computer program code for the system driven interface further comprises computer program code defining an animated figure in the mentor window to convey information audibly to the users. Additionally and/or alternatively, the computer program code for the system driven interface further comprises computer program code for providing text in the mentor window to convey information to the users.

In some embodiments the computer program code for the system driven interface further comprises computer program code for defining a respective avatar for each user. In some more specific embodiments, the computer program code for the system driven interface further comprises computer program code defining a respective set of controls to enable the user to control the respective avatar representing the user in an online interaction. In even more specific embodiments, the set of controls for controlling an avatar include a set of emoticons that represent various facial expressions, and when a user selects one of the emoticons the facial expressions and/or gestures of a respective avatar are changed either momentarily or for a prolonged period. Additionally and/or alternatively, the set of controls for controlling an avatar include a set of gestures described, and when a user selects one of the gestures a respective avatar is controlled to make the corresponding gesture.

In some embodiments, the computer program code for the system driven interface further comprises computer program code defining controls for enabling a user to customize the appearance of a respective avatar.

In some embodiments the software product also includes computer program instructions for: defining a user interface enabling a user to access functions of the online dating service; defining a subscriber database in which information about the users of the online dating service is stored in the form of respective subscriber profiles; and, defining a set of customs aspects that enables at least one of a user and the facilitator program to control the content provided to users.

In some embodiments the software product also includes computer program instructions defining a search engine that can be employed by users, through the user interface, to search for potential matches by filtering other subscriber profiles according to the criteria the user wishes potential matches to have. Additionally and/or alternatively, in some embodiments the software product also includes computer program instructions defining a matchmaking service that pairs users for online interactions according to a set of matchmaking criteria.

In some embodiments the software product also includes computer program instructions defining a personality test for determining the personality type of a user. In more specific embodiments, the personality test is one of Myers-Briggs, Holland codes, Minnesota Multiphasic Personality Inventory, Morrisby Profile, MEO PI-R, Enneagram Type Indicator, Thematic Apperception Test, and Kelly's Repertory Grid.

In some embodiments a facilitator program includes program instructions for delivering specialized content to users based on the personality type of at least one of the pair of users interacting online together using the online dating service. In some more specific embodiments, the specialized content delivered to users includes at least one of virtual scenarios, questions sets and hint sets.

In some embodiments the functions of the online dating service include level based dating controlled by the facilitator program.

According to yet another aspect of the invention there provided a method for facilitating online dating, the method comprising: providing each of a pair of users with a system driven interface through which content can be provided to the users through the use of a web-browser; providing content to the pair of users in the form of at lease one virtual scenario designed to elicit an emotional reaction within each of the users; and, enabling the users to interact with one another through the system driven interface.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a conceptual view of one very specific example of the organization of a software product for an online dating service according to aspects of the invention;

FIG. 2 is a simplified system depicting a general delivery option for an online dating service according to aspects of the invention;

FIG. 3 is a simplified screen layout showing an arrangement of an online dating website provided to users according to aspects of the invention;

FIG. 4 is flow chart depicting method steps for customizing the delivery of content from the online dating service to users according to aspects of the invention;

FIG. 5 is an example of a simplified look-up table provided to enable the customization functionality depicted in the flow chart shown in FIG. 4; and

FIG. 6 is a flow chart depicting method steps for guiding users through level based virtual dates according to aspects of the invention.

### DETAILED DESCRIPTION OF THE INVENTION

Previous attempts to facilitate online dating include a number of flaws. A conventional assumption underlying online dating is that giving individuals more control to search for and evaluate options should lead to better outcomes. However, generating more options may actually have adverse effects if the options are not evaluated in a manner that allows the evaluator to ascertain a more accurate impression of a person considered as a potential match. Yet online dating services typically only enable individuals to evaluate one another based on lists of attributes—which are used to create filters—and text based chat sessions or emails that are solely directed by the individuals. An individual can generate a multitude of potential matches with relative ease using the search functionality often included on an online dating website. The result is that online daters are implicitly motivated to seek out and try their luck with many different potential matches and may be less motivated to put in the effort needed to get to know a specific potential match and open themselves up for evaluation due to the number of alternatives that are available to replace those that cannot make it past a preliminary level of online interaction. That is, user driven online interactions allow users to remain emotionally distant and separated from others they interact with and do not encourage users to interact in a less guarded manner. In turn key personality information may not be revealed that can be evaluated to determine the potential for a more significant relationship.

In contrast, provided by aspects of the present invention is an online dating service that provides system driven interactions in addition to and/or alternative to user driven aspects of online dating. The online dating service provides a virtual setting in which two users at a time are presented with virtual scenarios to which they react and comment on. The virtual scenarios are more than mere images or a virtual environment to be navigated through, and instead include video clips (or animation) designed to elicit the emotional reactions of each user and to catalyze less guarded conversations between the users. According to aspects of the invention the video clips (or animation) contain content that is designed to encourage users to share their feelings, thoughts and observations on topics that may require each user to reveal aspects of their own personality and leaves little room for remaining emotionally distant and separated from the interaction. But even if one of the users tries to conceal an emotional reaction, the other user having also viewed the video clip may be looking for a particular reaction that conforms to their world view, value system, mind set or the like. And not having received a reaction from the first user (trying to avoid an issue) may provide the second user with implicit information about the first user. That is, the virtual scenario presented to the two users on the virtual date provides context to the interaction and any reaction by a first one of the users can be interpreted by a second one of the users to mean something based on the expectations of the second one of the users and vice versa. As a result, key personality information may be revealed that can be evaluated by others to determine the potential for a more significant relationship. Additionally, an online dating service provided by aspects of the invention may also provide questions to each user to prompt them to assess their own reactions and dating expectations (in addition to assessing the reactions of the other user they are on a virtual date with) after being presented with the content in a virtual scenario so that each user is encouraged to attempt to better understand their own dating needs and biases. For example, the content in a video clip may contain subject matter not typically discussed on a first date or subject matter that is controversial and unexpected given the context of the virtual date. With reference to the figures below other examples are provided that illustrate this point in further detail.

According to one aspect of the invention the video clips are presented in the context of a virtual date between two users subscribing to a common website hosting the online dating service. A user interface includes a chat window and a video window displaying one of several different virtual scenarios—presented as video clips or animated segments. In a more specific embodiment, the website user interface includes a “mentor” or help window. The mentor window may provide advice with respect to making conversation about the virtual scenario displayed, provide questions that the users are prompted to answer, explain the process of the virtual date and how to use the functions of the online dating service.

In some more specific embodiments, users are required to fill out a personality test in the form of a questionnaire. The results of the personality test for each user can then be used to select or change the type of content presented to the users or provide one of the two users participating in an online virtual date a hint as to what type of question could be posed to cause the other user to reveal something that might otherwise not be revealed during the online interaction. In such embodiments the mentor may be an animated figure that provides such information audibly and/or a window with text information that each of the users can refer to. In some embodiments, some of the information provided to each of the two users participating in an online virtual date is different than the information presented to the other user, while some of the information provided to each of the users is the same.

Additionally and/or alternatively, in some more specific embodiments, users are required to fill out a preferences questionnaire. The results of the preferences questionnaire for each user can then be used to select or change the type of content presented to the users or provide one of the two users participating in an online virtual date a hint as to what type of question could be posed to cause the other user to reveal something that might otherwise not be revealed during the online interaction. In such embodiments the mentor may be an animated figure that provides such information audibly and/or a window with text information that each of the users can refer to. In some embodiments, some of the information provided to each of the two users participating in an online virtual date is different than the information presented to the other user, while some of the information provided to each of the users is the same.

In yet another embodiment, each user is provided with an avatar that is displayed to other users during some online interactions (e.g. a virtual date). Each respective avatar is controllable by a corresponding user so as to communicate facial expressions and emotions. For example, an avatar can be controlled by its user on a virtual date to indicate an expression of boredom, good humor, interest or arousal. That is, an avatar can be used to communicate body language and/or presence that is otherwise not available in other online services. Moreover, in some more specific embodiments, each user may be able to specifically configure the appearance of their respective avatar in order to indicate to others their own sense of style, personality or fantasy.

Additionally and/or alternatively, aspects of the invention focus on how a user reveals information to another user in addition to what or even the type of information shared between users. This is accomplished by taking control of the online interaction between users away from the users and managing it at a system level. According to aspects of the invention a sub-program known as a facilitator is provided with the task of managing the interactions between users. In some embodiments, for example, the facilitator may be configured to provide time constraints for responses from users at the risk of penalties, such as premature termination of the interaction for attempting to avoid questions or taking too long to answer questions. The pressure of a system managed virtual date may induce users into less guarded conversations where they are not trying to come up with polished answers, but rather react to questions or video scenarios in ways true to their inherent and respective personalities.

The reactions of each of the users provide information about a user that is otherwise not easily captured in a list of attributes. Moreover, the reactions cannot be easily concealed or manipulated by the users since the reactions are required in real-time. As such, there is not sufficient time for a user to carefully construct a response that would falsely project an idealized image of himself/herself. However, even if a user does take a long time to react to a virtual scenario or respond to a question from another user inspired by a virtual scenario, the delay itself communicates something. For example, it may communicate that the user is guarded and emotionally distant or unavailable, which may be a critical aspect of their personality that others evaluating them for romantic compatibility may wish to know. In the alternative, a delayed response, may indicate that the user takes the time not to over react or react prematurely. The way in which a user responds and the actual response communicated combine to provide an image of the user that is not inferable from a list of attributes. One reason for this is that the information revealed during the online interactions, facilitated by aspects of the invention, have real time context beyond the control of the users and provided by the online dating service (in, for example, a virtual scenario), whereas, the context of a personal biography or list of attributes can be easily manipulated by the user. Another reason is that the users on virtual dates, having been presented with virtual scenarios according to aspects of the invention, are inherently spending more time evaluating one another as a result of participating in the virtual date controlled by the online dating service than users who may only be analyzing lists of attributes or text-based profiles garnered from search results.

Aspects of the invention may be embodied in a number of forms. For example, various aspects of the invention can be embodied in a suitable combination of hardware, software and firmware. In particular, some embodiments include, without limitation, entirely hardware, entirely software, entirely firmware or some suitable combination of hardware, software and firmware. In a particular embodiment, the invention is implemented in a combination of hardware and firmware, which includes, but is not limited to firmware, resident software, microcode and the like.

Additionally and/or alternatively, aspects of the invention can be embodied in the form of a computer program product that is accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device.

A computer-readable medium can be an electronic, magnetic, optical, electromagnetic, infrared, or semiconductor system (or apparatus or device) or a propagation medium. Examples of a computer-readable medium include a semiconductor and/or solid-state memory, magnetic tape, a removable computer diskette, a random access memory (RAM), a read-only memory (ROM), a rigid magnetic disk and an optical disk. Current examples of optical disks include, without limitation, compact disk-read only memory (CD-ROM), compact disk-read/write (CD-R/W) and DVD.

In accordance with aspects of the invention, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Additionally and/or alternatively, in accordance with aspects of the invention, a data processing system suitable for storing and/or executing program code will include at least one processor integrated with memory elements through a system bus.

Input/output (i.e. I/O devices)—including but not limited to keyboards, touch-pads, displays, pointing devices, etc.—can be coupled to the system either directly or through intervening I/O controllers.

Network adapters may also be coupled to the system to enable communication between multiple data processing systems, remote printers, or storage devices through intervening private or public networks. Modems, cable modems and Ethernet cards are just a few of the currently available types of network adapters.

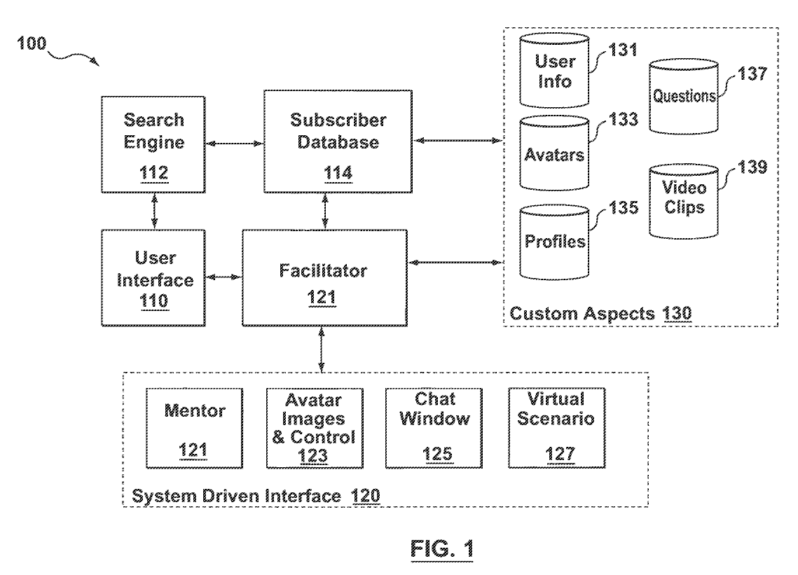

Referring to FIG. 1, shown is a conceptual view of one very specific example of the organization of a software product 100 for an online dating service according to aspects of the invention. Those skilled in the art will appreciate that a software product for an online dating service according to aspects of the invention can be organized and structured in a number of different ways while implementing the same functionality. Accordingly, the conceptual view of the software product 100 shown in FIG. 1 is provided only as a specific example of how one skilled in the art may choose to organize a software product for an online dating service in accordance with aspects of the invention. The conceptual view of the software product 100 is in no way meant to limit the scope of the claims. Those skilled in the art will appreciate an actual software product implementing the functionality described herein would include a suitable combination of source code, calls to system drivers and the like in order to be operable, and thus the functional blocks depicted in FIG. 1 are only provided to facilitate the understanding of the functionality of an online dating service in accordance with aspects of the invention.

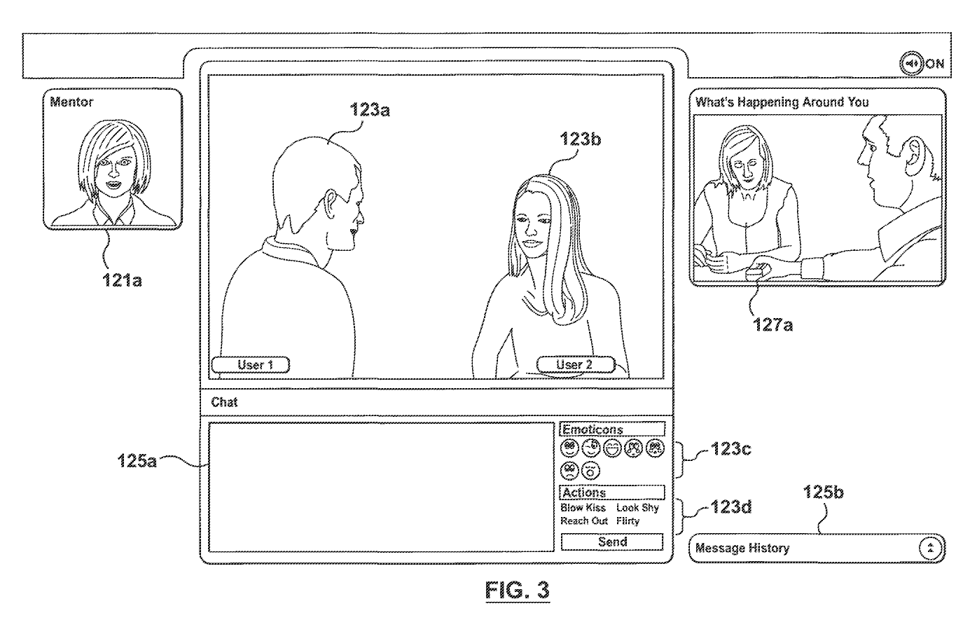

As noted above, an online dating service according to aspects of the invention is provided that takes control of the user interactions away from the users and manages it at a system level. As a result users are induced to spend more time evaluating potential matches and to reveal more information about themselves that is not easily captured in an attribute list. With specific reference to FIG. 1, user interactions are managed by a facilitator program 140. However, the operation of the facilitator program 140 is hidden from users. This is accomplished by limiting, and in most cases preventing, direct access to the facilitator program 140. Users are instead provided with two interfaces. The first is a user interface 110 and the second is a system driven interface 120. The system driven interface 120 may also be described as a user interface, however from the perspective of functionality, the system driven interface 120 is primarily controlled by the facilitator program 140 and not the user. More detailed aspects of the system driven interface 120 are described below with reference to FIG. 3.

The user interface 110 is provided to the users so that users can access functions (e.g. searching for potential matches and inputting information) of the online dating service. In some embodiments, users have the option to complete a detailed profile by providing various attributes about themselves (e.g. age, weight, location, photos, interests, etc.). This information is provided via the user interface 110 and is stored in a subscriber database 114. In some embodiments, a search engine feature 112 is also provided. Using the user interface 110 a user can search for potential matches by filtering other subscriber profiles according to the criteria the user wishes potential matches to have using the search engine feature 112. However, in accordance with aspects of the invention, interactions between users is preferably managed by the facilitator program 140 using the system driven interface 120 in order to encourage users to spend more time evaluating one another.

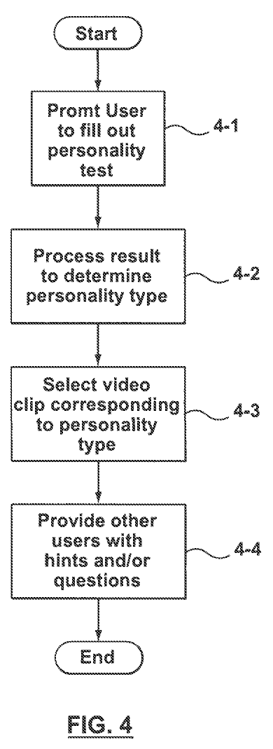

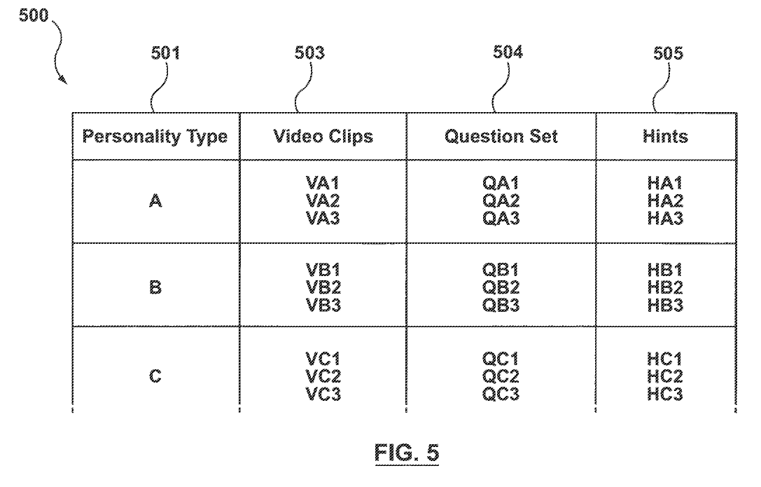

The subscriber database 114 can be linked to various custom aspects 130 of the software product 100. For example, as shown in FIG. 1, the custom aspects 130 of the software product 100 includes sub-databases for user information 131, avatars 133, profiles 135, question sets 137 and video clips (or animated segments) 139. The subscriber database 114 and the custom aspects 130 of the software product 100 can also be used by the facilitator program 140 to enhance or modify the content delivered via the system driven interface 120. An example of how the facilitator program 140 utilizes user information is described below with reference to FIGS. 4 and 5.

In various embodiments, the system driven interface 120 includes an assortment of features. In a first embodiment, the system driven interface 120 provides virtual scenarios 127 to users participating in a virtual date and each user is provided with a chat window 125 in which the users can exchange text information to one another. Additionally and/or alternatively, users may be permitted to communicate via audible messages to one another, for example, as facilitated by a voice over Internet Protocol (IP) standard. In a second embodiment, the users are additionally provided with a mentor or help window 121. The mentor window 121 may provide advice with respect to making conversation about the virtual scenario displayed, pose questions that the users are prompted to answer, and explain the process of the virtual date and how to use the functions of the online dating service. In a third embodiment, the users are provided with controllable avatars 123 that can be used to convey body language and/or presence.

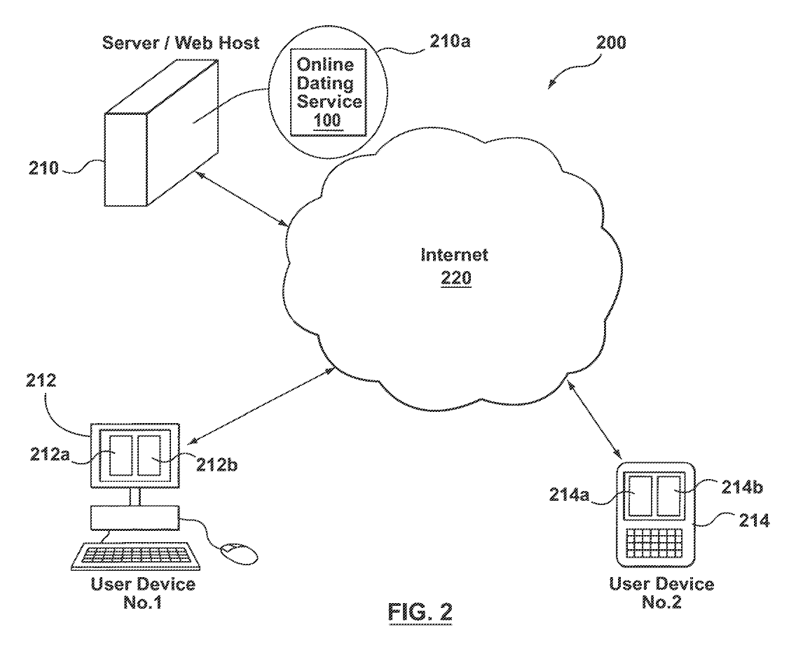

In operation, the system driven interface 120 is used to facilitate an online or virtual date in which the two users interact with one another. The virtual date may be set up by a matchmaking service employing the online dating service or by users that are subscribers to the online dating service provided by way of a website including the search engine feature 112. Turning to FIG. 2, with continued reference to FIG. 1, shown is a simplified system 200 depicting a general delivery option for an online dating service according to aspects of the invention. The system 200 includes a server (or web host) 210 and first and second user devices 212 and 214. The server 210 includes the software product 100 shown schematically in window 210a. The server 210 and the first and second user devices 212 and 214 are connected via the internet 220. First and second users (not shown) using the first and second user devices 212 and 214, respectively, access the server 210 which delivers interfaces of the online dating service to the first and second users. For example, the first user device 212 is provided with a user interface 212a and a system driven interface 212b from the software product 100 located and running on the server 210. Similarly, the second user device 214 is provided with a user interface 214a and a system driven interface 214b from the software product 100 located and running on the server 210. In this way, the first and second users can access the online dating service implemented by the software product 100 at different geographic locations.

FIG. 3 is a simplified screen layout 300 showing an arrangement of an online dating website provided to users on a virtual date according to aspects of the invention. More specifically, with further reference to FIG. 1, FIG. 3 provides an example of the arrangement of aspects of the system driven interface 120. In such an arrangement, the operation and even existence of the facilitator program 140 is hidden from the users. The screen layout 300 includes a mentor window 121a, a chat window 125a and a message history 125b, a display for virtual scenarios 127a and an avatar window 123.

As noted above the mentor window 121a provides advice with respect to making conversation about the virtual scenario displayed, poses questions that the users are prompted to answer and explains the process of the virtual date and how to use the functions of the online dating service. In FIG. 3, the mentor window 121a includes an animated figure/character 121b serving as the “mentor”.

The display for virtual scenarios 127a is used to deliver virtual scenarios in the form of video clips and/or animated segments to users on a virtual date that are specifically designed to elicit an emotional response from each of the users. For example, in one virtual scenario the users are presented with a video clip of another couple arguing about a relationship issue (e.g. marriage, children, money, job stress, sex, etc.). The users are prompted to discuss the content of the virtual scenarios using the chat window 125a. In some embodiments, as depicted in FIG. 3 the users are also represented by avatars or caricatures. For example, in FIG. 3, User 1 is depicted as a male avatar 123a with his back to the screen. The back of the avatar 123a is presented in this image because it is the view that User 1 would have of the interaction and User 1 is represented by the avatar 123a. User 2 is represented by avatar 123b, which has female characteristics and is facing the screen as if actually in front of User 1 controlling the male avatar 123a. The opposite arrangement would be presented to the user controlling avatar 123b. With further reference to FIG. 2, and for example only, User 1 accesses the online dating service using user device 212 and User 2 access the online dating service using user device 214.

Additionally and/or alternatively, portions of a virtual scenario can be presented in the avatar window 123. In such embodiments, the virtual scenario may contain content with which the users through use of the avatars can interact with while at the same time interacting with one another.

The avatar 123a is controlled by User 1 using control icons 123c and 123d. Controls 123c are provided in the form of emoticons that represent various facial expressions associated with feelings such as, for example only, surprise, delight, unhappiness, coyness and anger. By selecting one of the emoticons the facial expressions and/or gestures of the avatar 123a are changed either momentarily or for a prolonged period. Controls 123d are provided in the form of gestures described in text, such as, for example only, “blow kiss”, “look shy”, “flirt” and “reach out”. By selecting one of the gestures the avatar 123a is controlled to make the corresponding gesture. Avatar 123b is controlled in an identical manner, and the description of which is omitted for the sake of brevity.

Additionally and/or alternatively, avatars can be programmed to appear to touch one another or make other physical gestures. For example, in some embodiments, users may be enabled to control their respective avatars to hug, shake-hands or wave. These movements or gestures may also be made in response to text typed in the chat window 125a. To that end, the facilitator program 140 may include computer program code having instructions for monitoring the text typed in the chat window 125a, parsing the text for keywords corresponding to gestures avatars are enabled to make, and signaling the avatar controls to change the movements of avatars in response to the keywords identified in the chat window 125a. Keywords and/or text patterns may include, for example, “oops”, “lol”, “what?” which may be translated into gestures depicting bashfulness, laughter or a furrowed brow representing inquisition. Such keywords or text patterns along with corresponding gestures made by a respective avatar help users communicate body language or presence in real-time to other users.

Moreover, although FIG. 3 shows a male and a female avatar on a virtual date, other virtual dates facilitated by the system may include couples of the same sex, and the sexual characteristics of the avatars is in no way limiting to the use of the avatars by people of either gender.

Additionally and/or alternatively, in accordance with aspects of the invention the content delivered to users can be customized as a function of information obtained from users. For example, with further reference to the software product 100 shown in FIG. 1, the virtual scenarios presented to users can be a function of the user information 131, profile information 135, and answers to questions 137. In a very specific embodiment, this may include presenting content with themes or subject matter that a user will respond to or is sensitive to or otherwise. Additionally and/or alternatively, the content may contain information, scenes, noises or other stimulation directed to a user.

The software product 100 for an online dating service according to aspects of the invention may collect and process information from users in a number of ways. For example, the online dating service may include a psychological test in the form of a questionnaire having discrete answers that provide a score for each user. The respective score on the test may in turn be determinative of a particular psychological profile of a user. Psychological tests to determine personality types that may be employed include, without limitation, Myers-Briggs, Holland codes, Minnesota Multiphasic Personality Inventory, Morrisby Profile, MEO PI-R, Enneagram Type Indicator, Thematic Apperception Test, and Kelly's Repertory Grid. Such psychological tests each define a number of discrete personality types that users of the online dating service may be categorized under. The facilitator program 140 may use the personality type information to customize or choose respective content that will cause a user or a pair of users to feel more open to sharing personal information or cause the same users to react in ways that reveal information about themselves to others they interact with through the online dating service provided by aspects of the invention.

FIGS. 4 and 5 are provided to illustrate one example of how the content delivered to users accessing an online dating service according to aspects of the invention can be tailored to users of particular personality types. FIG. 4 is a flow chart depicting method steps for customizing the delivery of content from the online dating service to users, and FIG. 5 is an example of a simplified lookup table 500 provided to enable the customization functionality depicted in the flow chart in FIG. 4.

With reference to FIG. 5, the look-up table 500 is organized so that specialized content for each of three example personality types A, B and C can be accessed. The example personality types A, B and C do not correspond to any specific personality type determinable from an actual scientific personality test and are provided only for the sake of example in order to illustrate the example herein. Specifically, the look-up table 500 includes columns for personality type 501, video clips 503, question sets 504 and hints 505. Additionally and/or alternatively, the personality type column 501 may be designated as a key column in a database structure used to store the look-up table 500. The personality types column 501 is divided into rows, where each row corresponds to one of the personality types A, B or C. In the present example only three such rows are shown. However, those skilled in the art will appreciate that the number of such rows is determined by the number of personality types that can be determined using the personality test employed. For example, the Myers-Briggs personality test can determine up to sixteen different personality types.

The video clips column 503 (or virtual scenario column) provides a number of sub-rows for each personality type row. In the example shown in FIG. 5, there are three such sub-rows in the look-up table 500. Each sub-row corresponds to a different video clip or virtual scenario presented to the users. However, the video clips for different personality types in corresponding sub-rows are variations of one another. For example, the video clips VA1 and VA2 are video clips for two different scenarios designed for personality type A. The first video clip VA1 may be of a scene in a restaurant where two people (not the users) are having a heated discussion about politics, and the second video clip VA2 may be a scene in a bedroom where two people (not the users) are having an intimate conversation. However, both the first and second video clips VA1 and VA2 contain content that users with personality type A may be more receptive and/or reactive to. In contrast, third and fourth video clips VB1 and VB2 are the same scenes as those in the first and second video clips VA1 and VB2, respectively, with the modification that the content (of say the dialogue, body language or issue) is something that users with personality type B are more responsive and/or reactive to. That is, VA1 and VB1 contain the same broad themes or visuals, but the specific content is provided for personality types A and B, respectively.

Similarly, question sets listed in question set column 504 and hint sets listed in the hints column 505 are organized in the same way. However, the question sets and the hint sets correspond to specific video clips as well as specific personality types. For example, question set QA1 corresponds to questions for the users relating to video clip VA1. In another example, hint set HC3 corresponds to video clip VC3 for users with example personality type C. The hint sets (e.g. HB2) are provided either to the user with the corresponding personality type or those on a date with the corresponding personality type.

Additionally and/or alternatively, the virtual scenarios, question sets and hint sets may be a function of two users paired to participate in a virtual date. For example, if one of the users is of personality type A and the other is of type B, a video clip, used to present a virtual scenario may contain content that each will be more responsive and/or reactive to and possibly leave out content that neither is responsive and/or reactive to. The content that is left out may be content that users with personality type C are more responsive and/or reactive to. The number of possible combinations is a function of the personality test employed, and for the sake of brevity an exhaustive list of all combinations for each of the actual personality tests listed above is not provided. Nevertheless, the facilitator program 140 may be configured to select one or more of several variations on content and theme to present to users of the same or different personality types. Additionally and/or alternatively, the content provided in the table 500 may include information about user preferences. As such, in some embodiments it is not necessary to have users complete a personality test in order for the users to be provided with customized content. FIG. 4 illustrates example method steps to accomplish this function.

Starting at step 4-1 the method includes prompting a user to answer the questions of a personality test. The personality test may be a scientifically validated and recognized test, such as those listed above. Additionally and/or alternatively, the personality test may be designed for entertainment value (e.g. based on astrology or other superstitions). While such tests may not provide any real insight into human interactions or have any real effect on matchmaking, such tests may make an online dating service according to aspects of the invention more marketable or enjoyable, since such tests may be taken from popular magazines (e g. Cosmopolitan™ or Maxim™) or gleaned from entertainment fads that users enjoy or have knowledge of due to their exposure to popular culture (globally or in a specific region).

Step 4-2 includes evaluating the answers to the questions of the personality test provided by a user to determine which one of a number of discrete personality types the user has. At step 4-3, the method includes selecting content based on the personality type of one or more users. On a virtual date the two users are preferably shown the same video clip so as to avoid confusion. If the two users do not have the same personality types, content specific to one user may be selected or content that is specific to the combination of personality types may be selected to present to the pair of users participating on the virtual date.

Step 4-4 of the method includes providing hints and questions to the users based on either their own personality type or the personality type of the person they are interacting with or a combination thereof. For example, after or while viewing a particular video clip a first user, with personality type B, may be provided with questions to ask a second user, with personality type C. The questions may be designed to reveal something about the first user to those with personality type C and/or designed to encourage those with personality type C to reveal something in the answer to the question. Additionally and/or alternatively, the questions may be general in nature and applicable to all personality types. The hints may be provided in an identical manner. However, the purpose of the hints is to help each user understand the psychology of the other user they are interacting with, based on generalities that define each personality type. The specifics of questions and hints is a function of the personality test employed.

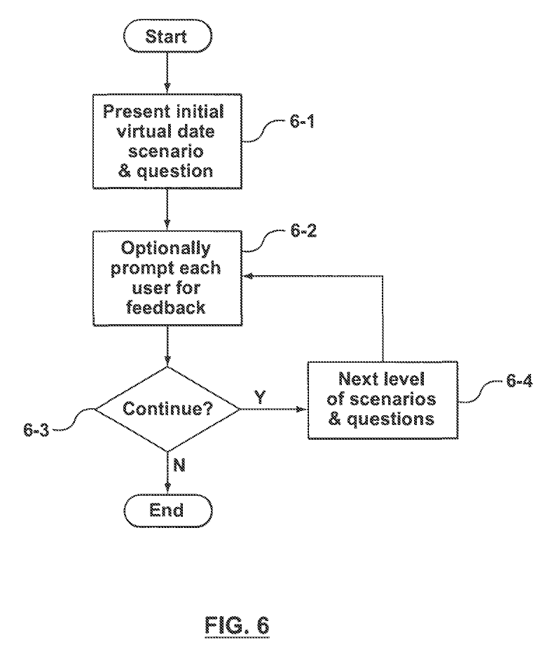

In accordance with other aspects of the invention, FIG. 6 is a flow chart depicting method steps for guiding users through level based virtual dates according to aspects of the invention. Level based online dating, according to aspects of the invention, can be used to help a pair of users get to know one another in a controlled manner. For example, according to some aspects of the invention, each online (virtual) date starting at the first date corresponds to content organized in levels. For example, the content for the first date may include preliminary exercises and topics of conversation that help a pair of users make introductions and share limited amounts of information with another. The content for subsequent levels ma y then include more complex behavioral exercises designed to help users share more about themselves to one another. To that end, FIG. 6 provides a flow chart for delivering level based dating content to users. Step 6-1 includes presenting an initial virtual date scenario and questions relevant and/or pertinent to a first date scenario. Step 6-2 includes optionally prompting each user to provide feedback about the initial date facilitated at step 6-1. Step 6-3 includes determining whether or not the pair of users will continue to subsequent levels of online dating. This step can be implemented by asking each user if he/she would like to continue getting to know the other person. If there is not agreement between the users to go on further online dates (no path, step 6-3), then the method ends and the users may go and search for other respective potential matches. If there is agreement (yes path, step 6-3), then the users proceed to participate in another online date with more advanced content. Accordingly, at step 6-4 the method includes providing content for subsequent dates at a higher level than the most recent date the two users participated in.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above disclosure.

1. A computer system for providing an online dating service, the system comprising:
a server computer hosting a software product implementing an online dating service having program instructions for:
a facilitator program for managing the interactions between a pair of users and content provided to the pair of users; and
a system driven interface, primarily controlled by the facilitator program and provided to respective users through use of a web-browser, for delivering content to the pair of users in order to provide context to interactions between the pair of users, the system driven interface including a display window for presenting a virtual scenario designed to elicit an emotional reaction from each of the pair of users interacting and a chat window in which the pair of users can discuss a virtual scenario presented.

2. A computer system according to claim 1 wherein the virtual scenario is presented in at least one of a video clip and an animated segment.

3. A computer system according to claim 2, further comprising a database storing a plurality of virtual scenarios.

4. A computer system according to claim 1, wherein the system driven interface further comprises a mentor window for providing the pair of users with at least one of advice with respect to making conversation about a virtual scenario displayed, questions that the users are prompted to answer, instructions explaining the process of a virtual date and how to use the functions of the online dating service.

5. A computer system according to claim 4, wherein an animated figure is provided in the mentor window to convey information audibly to the users.

6. A computer system according to claim 4, wherein text is displayed in the mentor window to convey information to the users.

7. A computer system according to claim 1, wherein the system driven interface includes a respective avatar for each user.

8. A computer system according to claim 7, wherein the system driven interface provides a user with a respective set of controls to enable the user to control the respective avatar representing the user in an online interaction.

9. A computer system according to claim 8, wherein the set of controls for controlling an avatar include a set of emoticons that represent various facial expressions, and when a user selects one of the emoticons the facial expressions, gestures and actions for a respective avatar are changed either momentarily or for a prolonged period.

10. A computer system according to claim 8, wherein the set of controls for controlling an avatar include a set of gestures described, and when a user selects one of the gestures a respective avatar is controlled to make the corresponding gesture.

11. A computer system according to claim 8, wherein the facilitator program includes computer program code having instructions for monitoring the text typed by at least one user, parsing the text for keywords or text patterns corresponding to gestures avatars are enabled to make, and signaling the avatar controls to change the movements of avatars in response to the keywords or text patterns identified.

12. A computer system according to claim 7, wherein the system driven interface provides controls for enabling a user to customize the appearance of a respective avatar.

13. A computer system according to claim 1, wherein the software product implementing the online dating service has further program instructions for:
a user interface enabling a user to access functions of the online dating service;
a subscriber database in which information about the users of the online dating service is stored in the form of respective subscriber profiles; and
a set of customs aspects that enables at least one of a user and the facilitator program to control the content provided to users.

14. A computer system according to claim 13, wherein the functions of the online dating service include a search engine that can be employed by users, through the user interface, to search for potential matches by filtering other subscriber profiles according to the criteria the user wishes potential matches to have.

15. A computer system according to claim 13, wherein the functions of the online dating service include a matchmaking service that pairs users for online interactions according to a set of matchmaking criteria.

16. A computer system according to claim 13, wherein the functions of the online dating service include a personality test for determining the personality type of a user.

17. A computer system according to claim 16, wherein the personality test is one of Myers-Briggs, Holland codes, Minnesota Multiphasic Personality Inventory, Morrisby Profile, MEO PI-R, Enneagram Type Indicator, Thematic Apperception Test, and Kelly's Repertory Grid.

18. A computer system according to claim 13, wherein the facilitator program includes program instructions for delivering specialized content to users based on the personality type of at least one of the pair of users interacting online together using the online dating service.

19. A computer system according to claim 18, wherein the specialized content delivered to users includes at least one of virtual scenarios, questions sets and hint sets.

20. A computer system according to claim 13, wherein the functions of the online dating service include a questionnaire for determining the preferences of a user.

21. A computer system according to claim 20, wherein the facilitator program includes program instructions for delivering specialized content to users based on the preferences of at least one of the pair of users interacting online together using the online dating service.

22. A computer system according to claim 21, wherein the specialized content delivered to users includes at least one of virtual scenarios, questions sets and hint sets.

23. A computer system according to claim 13, wherein the functions of the online dating service include level based dating controlled by the facilitator program.

24. A software product implementing an online dating service, the software product comprising computer program code for:
managing the interactions between a pair of users;
providing content to the pair of users interacting online accessing the online dating service through a web-browser, wherein the content provides real-time context to online interactions; and
a system driven interface for delivering content to the pair of users, the system driven interface including a display window for presenting a virtual scenario designed to elicit an emotional reaction from each of the pair of users interacting and a chat window in which the pair of users can discuss a virtual scenario presented.

25. A method for facilitating online dating, the method comprising:
providing each of a pair of users with a system driven interface through which content can be provided to the users through the use of a web-browser;
providing content to the pair of users in the form of at lease one virtual scenario designed to elicit an emotional reaction within each of the users; and
enabling the users to interact with one another through the system driven interface.
